(19) United States
(12) Patent Application Publication
(10) Pub. No.: US 2025/0188701 A1
(43) Pub. Date: Jun. 12, 2025

(54) ADVANCED PRECISION CONSTRUCTION FEATURES ON PILOT OPERATED MACHINES

(71) Applicant: Deere & Company, Moline, IL (US)

(72) Inventors: Sanket Pawar, Pune (IN); Alexander Nytko, Dubuque, IA (US); Kristen D. Cadman, Dubuque, IA (US); Jeffery W. Dobchuk, Saskatoon (CA); Kevin W. Campbell, Dubuque, IA (US); Nathan A. Edmondson, Greensboro, NC (US)

(21) Appl. No.: 18/537,549

(22) Filed: Dec. 12, 2023

(51) Int. Cl. E02F 3/32; E02F 3/43; E02F 9/02; E02F 9/12; E02F 9/20; E02F 9/22; E02F 9/26; E02F 9/28; F15B 13/06

(52) U.S. Cl. CPC E02F 3/32; E02F 3/439; E02F 9/02; E02F 9/123; E02F 9/2004; E02F 9/2203; E02F 9/2285; E02F 9/26; F15B 13/06; E02F 9/2292; E02F 9/2808; F15B 2211/6346

(57) ABSTRACT

A pilot hydraulic system of a work machine is upgraded to include advanced productivity features such as automatic grade control, electronic fencing and intelligent boom control. The directions input by the human operator via joystick and foot pedal input devices may be sensed with pressure sensors mounted on the hydraulic pilot valves associated with the input devices. Electrical signals from the pressure sensors may then be processed by the automated control system. Electrical command signals from the control system may be converted back to hydraulic pilot pressure signals using electro-hydraulic proportional control valves. Those hydraulic pilot pressure signals then direct the main hydraulic control valves which control operation of the various actuators of the work machine thus superimposing on the operator input various actuator limitations determined by the automated control system.

### FIELD OF THE DISCLOSURE

The present disclosure relates to a system for implementing advanced precision construction features such as grade control, electronic fencing, and intelligent boom control on a construction machine having pilot operated hydraulics.

### BACKGROUND

Many existing construction machines have pilot operated hydraulics for manual control of operation of the machines.

There is a need for an effective and economical system for the upgrading of such machines to add advanced electronic controls to supplement the manual operation of the machines.

### SUMMARY OF THE DISCLOSURE

In an embodiment a work machine may include an undercarriage including left and right crawler tracks driven by left and right hydraulic track drive actuators. A main frame is mounted on the undercarriage to be pivotable about a vertical pivot axis relative to the undercarriage. An excavator boom assembly extends from the main frame. The boom assembly includes a boom pivotally connected to the main frame, an arm pivotally connected to the boom, and a bucket pivotally connected to the arm. The machine includes a hydraulic swivel actuator, a boom actuator, an arm actuator, and a bucket actuator. A pilot operated main hydraulic control valve is associated with each of the actuators. Left and right joysticks and left and right foot pedals are used by the operator as operator input devices to control the machine. Each of the operator input devices has associated therewith a sensor for generating an electrical signal corresponding to the direction and distance of movement of the operator input devices. A controller is configured to receive the electrical signals and detect from the electrical signals the operator's input directing actuation of one or more of the actuators. The controller is further configured to generate one or more electrical command signals corresponding to a limited control actuation of one or more of the actuators based at least in part on one or more of the electrical signals, and based at least in part on an automated actuator control program configured to limit actuator movement based on preprogrammed control conditions. A control valve manifold is configured to receive electrical command signals and to generate pilot hydraulic pressure output signals corresponding to the electrical command signals. A pilot manifold is configured to receive the pilot hydraulic pressure output signals from the control valve manifold and direct the pilot hydraulic pressure output signals to one or more of the pilot operated main hydraulic control valves associated with one or more of the actuators.

Numerous objects, features and advantages of the present invention will be readily apparent to those skilled in the art upon a review of following description in conjunction with the accompanying drawings.

### BRIEF DESCRIPTION OF THE DRAWINGS

FIG. 1 is a left side view of a work machine, for example an excavator, including the advanced precision construction features of the present disclosure.

FIG. 2 is a schematic illustration of an operator's seat and control station of the excavator of FIG. 1, including left and right joystick controls and left and right foot pedal controls.

FIG. 3 is a schematic illustration of a control system for the work machine.

FIG. 4 is schematic hydraulic diagram of a representative portion of the control manifold showing the electro-hydraulic proportional flow control valves associated with one representative machine function.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

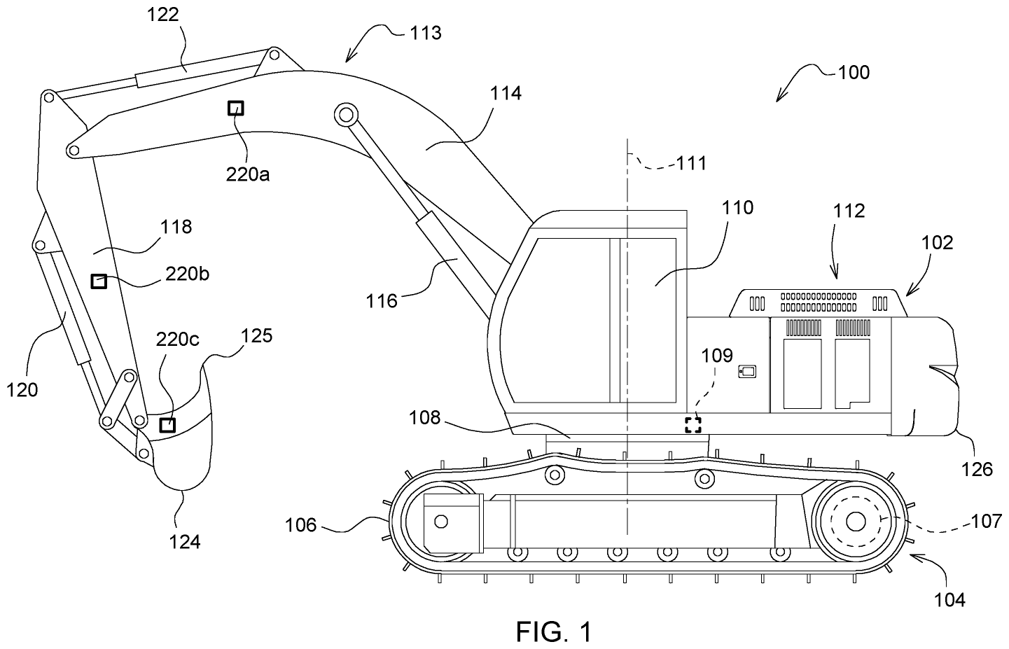

An example embodiment of a work machine is shown in FIG. 1. The machine is embodied as an excavator 100. The present disclosure is not limited, however, to an excavator and may extend to other work machines such as a loader, crawler, harvester, skidder, backhoe, feller buncher, motor grader, or any other work machine. As such, while the figures and forthcoming description may relate to an excavator, it is to be understood that the scope of the present disclosure extends beyond an excavator and, where applicable, the term “machine” or “work machine” will be used instead. The term “machine” or “work machine” is intended to be broader and encompass other vehicles besides an excavator for purposes of this disclosure.

Referring to FIG. 1, the machine 100 includes a chassis comprising an upper frame or main frame 102 pivotally mounted to an undercarriage 104. The upper frame 102 can be pivotally mounted on the undercarriage 104 by means of a swing pivot 108. The upper frame 102 is rotatable about 360 degrees about a vertical pivot axis 111 relative to the undercarriage 104 on the swing pivot 108. A hydraulic motor swivel actuator 109 can drive a gear train (not shown) for pivoting the upper frame 102 about the swing pivot 108.

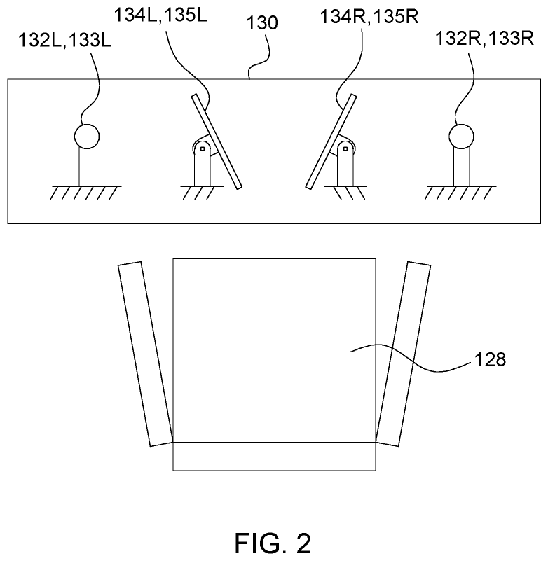

The undercarriage 104 can include a pair of ground-engaging mechanisms such as tracks 106 on opposite sides of the undercarriage 104 for moving along the ground. Each of the tracks 106 may include a hydraulic track drive actuator 107 such as a hydraulic motor. Alternatively, the machine 100 can include more than two tracks or wheels for engaging the ground. The upper frame 102 includes a cab 110 in which the machine operator controls the machine. As shown schematically in FIG. 2, the cab 110 can include an operator's seat 128 and a control station 130.

The control station 130 may include left and right joystick controlled operator input assemblies 132L and 132R, left and right foot pedal controlled operator input assemblies 134L and 134R, as well as other controls. The operator input to the left and right joystick controlled operator input assemblies 132L and 132R include left and right joysticks 133L and 133R. The operator input to the left and right foot pedal controlled operator input assemblies 134L and 134R include left and right foot pedals 135L and 135R. The human operator can actuate one or more of the controls of the control station 130 for purposes of operating the work machine 100. As is further explained below, the left and right joystick controlled operator input assemblies 132L and 132R may control machine functions such as the boom actuators, arm actuators, bucket actuators and swivel actuators, and the left and right foot pedal controlled operator input assemblies 134L and 134R may control the hydraulic track drive actuators.

In one embodiment the left and right joystick controlled operator input assemblies 132L and 132R are left and right joystick controlled hydraulic pilot valve assemblies 132L and 132R. In one embodiment the left and right foot pedal controlled operator input assemblies 134L and 134R are left and right foot pedal controlled hydraulic pilot valve assemblies 134L and 134R.

The machine 100 also includes an excavator boom assembly 113 that extends from the upper frame 102 adjacent to the cab 110. The boom assembly 113 includes a boom 114, and arm 118 and a bucket 124. The boom 114 is rotatable about a vertical arc by actuation of a pair of hydraulic boom cylinders or boom actuators 116. The arm 118, also sometimes referred to as a dipperstick, is rotatably mounted at one end of the boom 114 and its position is controlled by a hydraulic arm cylinder or arm actuator 122. At the end opposite the boom 114, the arm 118 is rotatably coupled to the work implement or bucket 124 that is pivotable relative to the arm 118 by means of a hydraulic implement pivoting cylinder 120 which may be referred to as a bucket actuator 120. Bucket 124 has a bucket tip 125.

The upper frame 102 of the machine 100 includes an outer shell cover over an engine assembly 112. At an end opposite the cab 110, the upper frame 102 includes a counterweight body 126. The counterweight body 126 comprises a housing filled with material to add weight to the machine and offset a load collected in the bucket 124. The offset weight can improve the craning or digging performance characteristics of the machine 100.

The operator of the machine 100 may manually control the hydraulic boom actuators 116, the hydraulic arm actuators 122, the hydraulic bucket actuators 120 and the hydraulic swivel actuator 109. As schematically shown in FIG. 2 these controls may include the left hand joystick 133L and a right hand joystick 133R on opposite sides of the operator's seat 128. The two joysticks typically are configured to control bi-directional movement of the various hydraulic actuators according to either an ISO control pattern or an SAE control pattern. For example, in an ISO control pattern the two joysticks are configured as follows:
Left hand left=Swing left
Left hand right=Swing right
Left hand forward=Arm 118 (Dipper) away
Left hand back=Arm 118 (Dipper) close
Right hand left=Bucket 124 curl in (closed)
Right hand right=Bucket 124 curl out (dump)
Right hand forward=Main Boom 114 down
Right hand back=Main Boom 114 up.

For a machine with the ISO control pattern, the left joystick controlled operator input assembly 132L may be described as being configured to direct a first machine action (arm actuator 122 for arm 118) in response to forward and reverse motions of the left joystick and to direct a second machine action (swivel actuator 109) in response to left and right motions of the left joystick 133L. The right joystick controlled operator input assembly 132R may be described as being configured to direct a third machine action (boom actuator 116 for boom 114) in response to forward and reverse motions of the right joystick and to direct a fourth machine action (bucket actuator 120 for bucket 124) in response to left and right motions of the right joystick 133R. It will be understood that references to first, second, third and fourth machine actions are only names and do not imply any order of implementation of machine actions. Furthermore, the machine actions associated with the various operator input assemblies may be varied as desired.

The operator of the machine 100 may also manually control the forward and reverse motion of the left and right crawler tracks 106 by manipulation of the left and right foot pedals 135L and 135R.

In a manually controlled work machine the left hand and right hand joysticks directly control spool valves which direct operating hydraulic pressure to the various actuators. In a pilot controlled work machine the left hand and right hand joysticks control pilot valves which direct pilot pressure to main operating valves which in turn direct operating hydraulic pressure to the various actuators.

The present disclosure is directed to an improvement in pilot controlled work machines which provides for interaction of an automated control system to provide various advanced precision construction control features to a pilot actuated hydraulic valve structure. One example of such automated control systems is an automated grade control system whereby the work machine is configured to automatically control the grade, i.e. elevation, and/or the position of the work implement. Another example of such automated control system has a virtual or electronic “fence mode” wherein the control system is configured to prevent the work tool from moving past a virtual fence established within the control system. And another example is an intelligent boom control system.

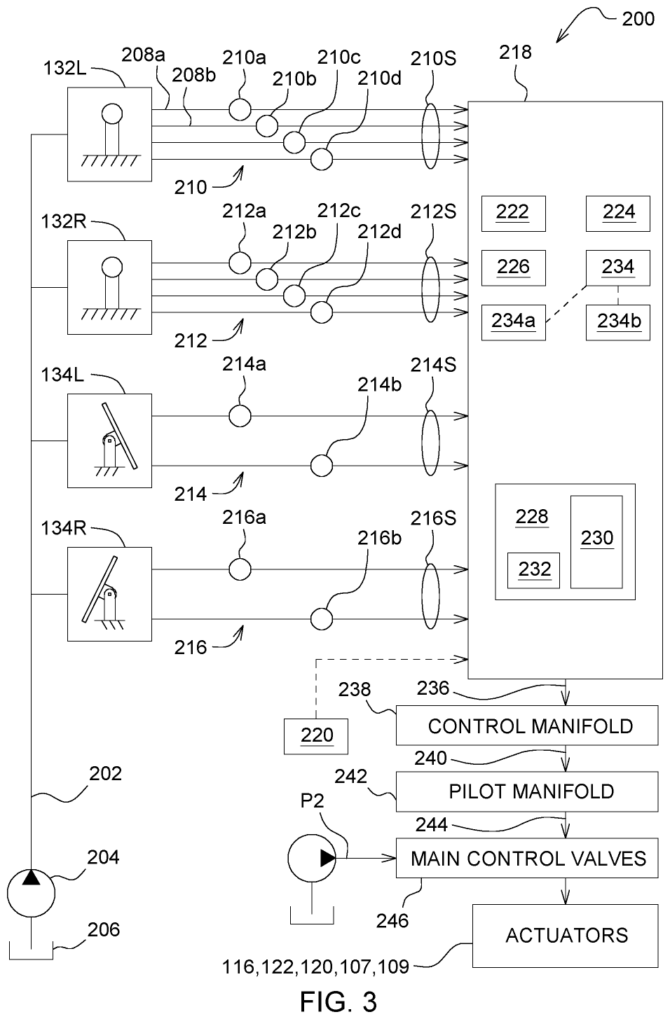

FIG. 3 schematically illustrates a high level view of both the electronic and hydraulic aspects of a control system 200 of the machine 100. In FIG. 3 hydraulic communication lines carrying hydraulic fluid are shown in solid lines and electrical communication lines carrying electrical signals are shown in dashed lines.

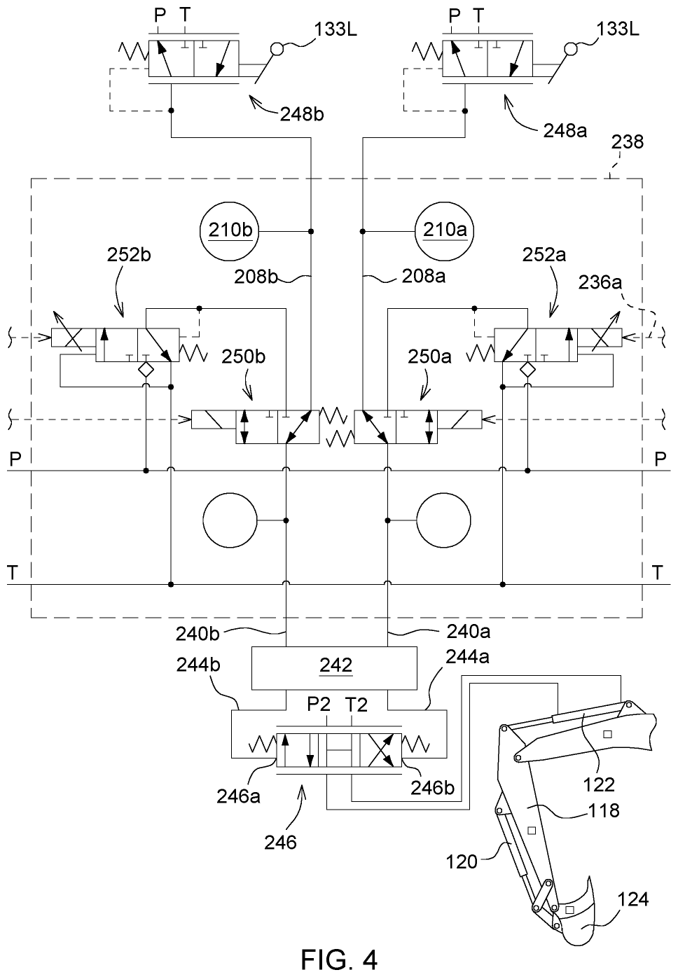

On the left side of FIG. 3 the left and right joystick controlled operator input assemblies 132L and 132R, and the left and right foot pedal controlled operator input assemblies 134L and 134R are schematically illustrated. As is further described below with regard to FIG. 4, each of the joysticks or foot pedals may control a hydraulic pilot valve which generates a hydraulic pilot fluid pressure corresponding to a direction and extent of movement of the joystick or the foot pedal.

The hydraulic pilot valves associated with each of the operator input assemblies receive pilot hydraulic fluid under pressure through a pilot pressure supply line 202 from pilot pressure pump 204 and return pilot hydraulic fluid to pilot hydraulic fluid tank 206 through pilot output line 208.

A first input sensor 210 is connected to the left joystick controlled hydraulic pilot valve assembly 132L and configured to provide a first electrical signal 210S corresponding to the direction and distance of movement of the left joystick. As shown in FIG. 3, the first input sensor 210 may include a first plurality of input sensors 210a, 210b, 210c and 210d associated with the four directions forward, rearward, left and right of the left joystick.

A second input sensor 212 is connected to the right joystick controlled hydraulic pilot valve assembly 132R and configured to provide a second electrical signal 212S corresponding to the direction and distance of movement of the right joystick. As shown in FIG. 3, the second input sensor 212 may include a second plurality of input sensors 212a, 212b, 212c and 212d associated with the four directions forward, rearward, left and right of the right joystick.

A third input sensor 214 is connected to the left foot pedal controlled pilot valve assembly 134L and configured to provide a third electrical signal 214S corresponding to the direction and distance of movement of the left foot pedal. As shown in FIG. 3, the third input sensor 214 may include a third plurality of input sensors 214a and 214b associated with the forward and rearward pivoting of the left foot pedal.

A fourth input sensor 216 is connected to the right foot pedal controlled pilot valve assembly 134R and configured to provide a fourth electrical signal 216S corresponding to the direction and distance of movement of the right foot pedal. As shown in FIG. 3, the fourth input sensor 216 may include a fourth plurality of input sensors 216a and 216b associated with the forward and rearward pivoting of the right foot pedal.

It will be understood that each of the first, second, third and fourth electrical signals 210S, 212S, 214S and 216S may include multiple signals.

In one embodiment each of the input sensors is a hydraulic pressure sensor that generates an electrical output signal corresponding to the detected hydraulic pressure. It will be understood that for example, when one of the joysticks is moved forward, the hydraulic pilot valve associated with that forward movement will generate an increase in pressure in one of its sensors 210 which will identify the “direction” of movement of the joystick. The magnitude of that increase in pressure will correspond to the distance or extent of movement of the joystick. The same is true for the foot pedal inputs.

In an alternative embodiment the input sensors may be electro-mechanical position sensors which directly detect the physical movement of the operator input device (joystick or foot pedal). Examples of such input sensors are string potentiometers and LVDT sensors, or any mechanism that can provide a joystick or foot pedal position in terms of an electrical signal.

It will be appreciated that the first, second, third and fourth electrical signals 210S, 212S, 214S and 216S will represent the input control directions from the human operator manipulating the various operator input assemblies and will correspond to a desired manipulation of the various machine actuators to control movement and operation of the work machine 100.

Those signals 210S, 212S, 214S and 216S are received by an electronic controller 218. The controller 218 may be part of the machine control system of the work machine 100, or it may be a separate control module. The controller 218 may be mounted in the operator's station 130. The controller 218 is configured to receive input signals from various sensors. The signals transmitted from the various sensors to the controller 218 are schematically indicated in FIG. 3 by dashed lines connecting the sensors to the controller with an arrowhead indicating the flow of the signal from the sensor to the controller 218.

For example, pressure signals from the pressure sensors such as 210S, 212S, 214S and 216S will be received so that the controller can monitor the hydraulic pressure from each of the hydraulic pilot valves associated with the various operator input assemblies.

The controller 218 will also receive position input data from various position feedback sensors 220 associated with the various machine components such as boom 114, arm 118, bucket 124, and tracks 106. The feedback position sensors 220 may for example include inertial measurement units (IMU's) 220a, 220b and 220c mounted on the boom 114, the arm 118 and the bucket 124, respectively. The position feedback sensors may also include rotation sensors for detecting rotation of the track drive motors 107.

Similarly, the controller 218 will generate control signals for controlling the operation of the various machine components.

Controller 218 includes or may be associated with a processor 222, a computer readable medium 224, a data base 226 and an input/output module or control panel 228 having a display 230. An input/output device 232, such as a keyboard, joystick or other user interface, is provided so that the human operator may input instructions to the controller. The control panel 228 may include or be in addition to the operator's station 130 previously described. The input/output device 232 may include or be in addition to the various operator input assemblies 132L, 132R, 134L and 134R previously described. It is understood that the controller 218 described herein may be a single controller having all of the described functionality, or it may include multiple controllers wherein the described functionality is distributed among the multiple controllers.

Various operations, steps or algorithms as described in connection with the controller 218 can be embodied directly in hardware, in a computer program product 234 such as a software module executed by the processor 218, or in a combination of the two. The computer program product 234 can reside in RAM memory, flash memory, ROM memory, EPROM memory, EEPROM memory, registers, hard disk, a removable disk, or any other form of computer-readable medium 224 known in the art. An exemplary computer-readable medium 224 can be coupled to the processor 218 such that the processor can read information from, and write information to, the memory/storage medium. In the alternative, the medium can be integral to the processor. The processor and the medium can reside in an application specific integrated circuit (ASIC). The ASIC can reside in a user terminal. In the alternative, the processor and the medium can reside as discrete components in a user terminal.

The term “processor” as used herein may refer to at least general-purpose or specific-purpose processing devices and/or logic as may be understood by one of skill in the art, including but not limited to a microprocessor, a microcontroller, a state machine, and the like. A processor can also be implemented as a combination of computing devices, e.g., a combination of a DSP and a microprocessor, a plurality of microprocessors, one or more microprocessors in conjunction with a DSP core, or any other such configuration.

Particularly the controller 218 may be programmed to generate electrical command signals corresponding to a limited control actuation of the one or more actuators based at least in part on the first, second, third and fourth electrical signals 210S, 212S, 214S and 216S, and based at least in part on an automated actuator control program configured to limit actuator movement based on preprogrammed control conditions. The automated actuator control program may for example be an automatic grade control program (GC), an automatic electronic fence program (EF) or a intelligent boom control program (IBC).

In the context of an automatic grade control system for an excavator 100 such as shown in FIG. 1 the human operator will typically only command the function of the arm 118, while the boom 114 and bucket 124 are controlled by the controller 218 to keep the bucket tip 125 on the desired grade line. The bucket tip 125 may be referred to as a functional component 125 of the work machine. Thus, a grade control program may provide command signals configured to control actuation of the boom actuator 116, the arm actuator 122 and the bucket actuator 120. In other embodiments the grade control program may further provide command signals configured to control actuation of the swivel actuator 109 and/or the track actuators 107. In the context of an automatic grade control system the preprogrammed control conditions may include the desired grade to be achieved at each point within an external reference system (external to the machine 100) such as a GPS system. The project plan may include a map of desired grade (z position) as a function of the x, y position of the bucket tip within the external reference system.

In the context of a virtual or electronic fence system, if the controller 218 determines that the human operator is swinging the boom 114 into forbidden territory the controller 218 may for example limit the permissible swinging movement of the boom 114. Another example of an electronic fence program would include the detection of persons in the path of the machine 100 and command the machine 100 to stop. Depending on the nature of the electronic fence program and the obstacle or danger detected, the electronic fence program may need to operate any of the boom actuator 116, the arm actuator 122, the bucket actuator 120, the swivel actuator 109 and/or the track actuators 107. In the context of an electronic fence control system the preprogrammed control conditions may include identification of boundaries beyond which the machine 100 or a component thereof is not permitted to move; or the preprogrammed control conditions may include identification of obstacles which the machine 100 must avoid.

In the context of an intelligent boom control program the program may provide command signals configured to control actuation of the boom actuator 116, the arm actuator 122 and the bucket actuator 120. In the context of the intelligent boom control program the preprogrammed control conditions may include preferred combinations of movements of boom, arm and bucket to achieve a desired trajectory and velocity of the bucket tip for example.

The automated actuator control program may for example include two main software components indicated as 234a and 234b in FIG. 3. Software component 234a may be referred to as a GC/EF/IBC Control System software component. Software component 234b may be referred to a Manifold Control System software component.

The GC/EF/IBC Control System software component 234a may be any one of a number of existing software packages configured to generate desired function velocities and directions of a given machine component. For example, a grade control software package may generate a desired trajectory and velocity of the bucket tip 125 corresponding to the input direction from the human operator and corresponding to a preprogrammed desired grade to be maintained for the excavating operation.

The Manifold Control System software package may then determine the appropriate actions of each of the relevant machine actuators such as boom actuator 116, arm actuator 122, bucket actuator 120, track drive actuators 107 and/or swivel actuator 109, and potentially other actuators, to achieve the desired trajectory and velocity of the operable machine component such as the bucket tip 125. The bucket tip 125 may be referred to as a functional component 125 of the work machine. The Manifold Control System software package may for example generate proportional control signals 236 which are directed to a control manifold 238 to control various electro-hydraulic proportional flow control valves of control manifold 238 as further described below with reference to FIG. 4. As described below regarding FIG. 4, those electro-hydraulic proportional flow control valves will generate pilot hydraulic pressure output signals 240 which are sent to a pilot manifold 242 which directs those pilot hydraulic pressure signals via lines 244 to an appropriate one of the main hydraulic control valves 246 associated with the appropriate one of the functional actuators such as such as boom actuator 116, arm actuator 122, bucket actuator 120, track drive actuators 107 and/or swivel actuator 109.

FIG. 4 is a schematic illustration of those portions of the control system 200 corresponding to one of the operator input assemblies controlling one hydraulic actuator. In this case the forward/rearward operation of the left joystick 133L to control the arm actuator 122 of a machine operating using an ISO control pattern for an excavator is illustrated. The control arrangements for each of the other actuators is substantially identical.

The left joystick controlled operator input assembly 132L includes the left joystick 133L and four hydraulic pilot valves 248. In FIG. 4 only two of the hydraulic pilot valves 248a and 248b associated with the forward and reverse motion of the left joystick 133L are shown. The joystick 133L is configured to move the first hydraulic pilot valve 248a when the joystick 133L is moved in a first forward direction and to move the second hydraulic pilot valve 248b when the joystick 133L is moved in a second rearward direction.

FIG. 4 also shows the main control valve 246 associated with operation of the arm actuator 122 for arm 118. The main control valve 246 includes first and second pilot chambers 246a and 246b. A first pilot pressure control line 244a from pilot manifold 242 is connected to the first pilot chamber 246a. A second pilot pressure control line 244b from pilot manifold 242 is connected to the second pilot chamber 246b. The main control valve 246 will control flow of operating hydraulic fluid at a hydraulic operating pressure from an operating hydraulic fluid source P2 to the hydraulic arm actuator 122, and return of hydraulic fluid from the actuator 122 to an operating hydraulic fluid tank T2. It will be understood that there will be such an arrangement as shown in FIG. 4 associated with each of the hydraulic actuators to be controlled, such as the boom actuator 116, the hydraulic arm actuator 122, the hydraulic bucket actuator 120, and the hydraulic motor 109 that pivots the upper frame 102 about the undercarriage 104 on the swing pivot 108, and each of the hydraulic track actuators 109.

In FIG. 4 the details internal to the control manifold 238 are shown for the representative operation of the arm actuator 122. On the right hand side of the dashed box representing the control manifold 238 a pilot output line 208a from hydraulic pilot valve 248a is seen. In the pilot output line 208a there is disposed an on/off valve 250a. When the on/off valve 250a is in the “off” position as illustrated, hydraulic pilot pressure flows directly through the on/off valve 250a to a pilot pressure signal line or output line 240a, and the control system does not affect the manual operation of the machine 100. When the on/off valve 250a is shifted to the right hand position, flow from hydraulic pilot valve 248a is blocked and an electro-hydraulic proportional control valve 252a becomes active.

The electro-hydraulic proportional flow control valve 252a is connected to a hydraulic pilot pressure source P and hydraulic pilot fluid return tank T. The electro-hydraulic proportional flow control valve 252a can pass through to the pilot hydraulic pressure output/signal line 240a anywhere between 0% and 100% of the available hydraulic pilot pressure from source P depending upon the proportional control signal 236a received from controller 218.

Also seen in FIG. 4 are the pressure sensors 210a and 210b of the first plurality of input sensors 210 associated with the left joystick controlled operator input assembly 132L. Additionally, output pressure sensors 254a, 254b are shown which provide a confirmation of the output hydraulic pilot pressure signals 240a, 240b.

The left side of the control manifold 238 shown in FIG. 4 similarly shows a second on/off valve 250b, a second electro-hydraulic proportional flow control valve 252b and a second pilot hydraulic pressure signal/output line 240b.

The pilot hydraulic pressure signals 240a and 240b are directed via lines 244a and 244b to the pilot chambers 246a and 246b of the main hydraulic control valve 246 associated with the arm actuator 122. Depending on the position of the main hydraulic control valve 246, high pressure hydraulic operating fluid is provided in a controlled amount from the hydraulic operating fluid source P2 to the arm actuator 122 to extend or retract the actuator 122. Return hydraulic operating fluid is returned to hydraulic operating fluid tank T2.

The system described herein allows advanced precision construction features such as grade control, electronic fencing, and intelligent boom control to be implemented on a construction machine having pilot operated hydraulics. The existing pilot operated hydraulic control system may be maintained. By tapping into the pressure lines from the pilot valves with pressure sensors such as 210, 212, 214, 216 the operator's input directions may be converted to electrical signals which are processed by the advanced precision construction software packages. Then the output signals from the software may be converted back to pilot hydraulic pressure signals via the control manifold 238 to control the pilot operated main control valves 246. Such a system may be readily retrofitted onto existing pilot hydraulic controlled machines or may be installed as original equipment.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1: An work machine, comprising:
an undercarriage including left and right crawler tracks driven by left and right hydraulic track drive actuators, respectively;
a main frame mounted on the undercarriage to be pivotable about a vertical pivot axis relative to the undercarriage;
a hydraulic swivel actuator configured to swivel the main frame on the undercarriage about the vertical pivot axis;
an excavator boom assembly extending from the main frame, the boom assembly including a boom pivotally connected to the main frame, an arm pivotally connected to the boom, and a bucket pivotally connected to the arm;
a hydraulic boom actuator configured to pivot the boom relative to the main frame;
a hydraulic arm actuator configured to pivot the arm relative to the boom;
a hydraulic bucket actuator configured to pivot the bucket relative to the arm;
a plurality of pilot operated main hydraulic control valves one of which is associated with each of the actuators for directing hydraulic operating pressure to the respective actuator;
a left joystick controlled operator input assembly configured to direct a first machine action in response to forward and reverse motions of the left joystick and to direct a second machine action in response to left and right motions of the left joystick;
a right joystick controlled operator input assembly configured to direct a third machine action in response to forward and reverse motions of the right joystick and to direct a fourth machine action in response to left and right motions of the right joystick;
wherein the first, second, third and fourth machine actions include in any order actuation of the swivel actuator, the boom actuator, the arm actuator and the bucket actuator;
a left foot pedal controlled operator input assembly configured to direct the left track drive actuator;
a right foot pedal controlled operator input assembly configured to direct the right track drive actuator;
a first input sensor connected to the left joystick controlled pilot valve assembly and configured to provide a first electrical signal corresponding to a direction and distance of movement of the left joystick;
a second input sensor connected to the right joystick controlled pilot valve assembly and configured to provide a second electrical signal corresponding to a direction and distance of movement of the right joystick;
a third input sensor connected to the left foot pedal controlled pilot valve assembly and configured to provide a third electrical signal corresponding to a direction and distance of movement of the left foot pedal;
a fourth input sensor connected to the right foot pedal controlled pilot valve assembly and configured to provide a fourth electrical signal corresponding to a direction and distance of movement of the right foot pedal;
a controller configured to:
receive the first, second, third and fourth electrical signals;
detect from the first, second, third and fourth electrical signals an operator's input directing actuation of one or more of the actuators; and
generate one or more electrical command signals corresponding to a limited control actuation of the one or more of the actuators based at least in part on one or more of the first, second, third and fourth electrical signals, and based at least in part on an automated actuator control program configured to limit actuator movement based on preprogrammed control conditions;
a control valve manifold configured to receive the one or more electrical command signals and to generate one or more pilot hydraulic pressure output signals corresponding to the one or more electrical command signals; and
a pilot manifold configured to receive the one or more pilot hydraulic pressure output signals from the control valve manifold and direct the one or more pilot hydraulic pressure output signals to one or more of the pilot operated main hydraulic control valves associated with the one or more of the actuators.

2: The work machine of claim 1, wherein:
the left joystick controlled operator input assembly is a left joystick controlled hydraulic pilot valve assembly;
the right joystick controlled operator input assembly is a right joystick controlled hydraulic pilot valve assembly;
the first input sensor includes a first plurality of hydraulic pressure sensors; and
the second input sensor includes a second plurality of hydraulic pressure sensors.

3: The work machine of claim 2, wherein:
the left foot pedal controlled operator input assembly is a left foot pedal controlled hydraulic pilot valve assembly;
the right foot pedal controlled operator input assembly is a right foot pedal controlled hydraulic pilot valve assembly;
the third input sensor includes a third plurality of hydraulic pressure sensors; and
the fourth input sensor includes a fourth plurality of hydraulic pressure sensors.

4: The work machine of claim 1, wherein:
the first input sensor includes a first plurality of joystick position sensors; and
the second input sensor includes a second plurality of joystick position sensors.

5: The work machine of claim 1, wherein:
the automated actuator control program includes a grade control program.

6: The work machine of claim 5, wherein:
the grade control program provides command signals configured to control actuation of the boom actuator, the arm actuator and the bucket actuator.

7: The work machine of claim 6, wherein:
the grade control program further provides command signals configured to control actuation of the swivel actuator.

8: The work machine of claim 6, wherein:
the grade control program provides command signals configured to control actuation of the track actuators.

9: The work machine of claim 1, wherein:
the automated actuator control program includes an electronic fence program.

10: The work machine of claim 9, wherein:
the electronic fence program provides command signals configured to control actuation of the boom actuator, the arm actuator, the bucket actuator, the swivel actuator and the track actuators.

11: The work machine of claim 1, wherein:
the automated actuator control program includes an intelligent boom control program.

12: The work machine of claim 11, wherein:
the intelligent boom control program provides command signals configured to control actuation of the boom actuator, the arm actuator and the bucket actuator.

13: The work machine of claim 1, wherein:
the control valve manifold includes a plurality of electro-hydraulic proportional flow control valves; and
the controller configuration to generate the electrical command signals includes a configuration to first generate a desired trajectory and velocity of a functional component of the work machine, and then generate the electrical command signals to the electro-hydraulic proportional flow control valves associated with one or more of the actuators to achieve the desired trajectory and velocity of the functional component of the work machine.

14: The work machine of claim 13, wherein:
the functional component of the work machine is a bucket tip of the bucket; and
the one or more of the actuators includes the boom actuator, the arm actuator and the bucket actuator.
